(19) United States
(12) Patent Application Publication
(10) Pub. No.: US 2023/0313574 A1
(43) Pub. Date: Oct. 5, 2023

(54) DUAL SLIDING DOORS WITH ASYMMETRIC LATCH CONFIGURATION AND OVERLAPPING EDGES

(71) Applicant: Honda Motor Co., Ltd., Tokyo (JP)

(72) Inventors: Joji GOTO, Saitama (JP); Takashi FUKAHORI, Saitama (JP); Yuichiro SAIKI, Wako (JP); Kenichiro KAGAWA, Saitama (JP); Hiroshi SHINGU, Walled Lake, MI (US)

(21) Appl. No.: 17/708,192

(22) Filed: Mar. 30, 2022

(51) Int. Cl. E05B 83/38; B60J 5/06; E05B 83/40; B62D 25/06; B62D 25/20

(52) U.S. Cl. CPC E05B 83/38; B60J 5/06; B62D 25/20; B62D 25/06; E05B 83/40

(57) ABSTRACT

An asymmetric latch configuration for a dual sliding door system in a motor vehicle is disclosed. The dual sliding door system includes a front sliding door and a rear sliding door. One of the two doors is configured with a single latch that secures to a latch striker on the vehicle body. The other of the two doors is configured with three latches that secure to three associated latch strikers on the vehicle body. The sliding doors may also include overlapping lateral edges that reduce lateral separation during a collision.

### BACKGROUND

The embodiments relate generally to systems for securing sliding doors in a vehicle, and in particular to systems for securing sliding doors using latches.

Sliding doors in vehicles generally include roller assemblies that slide along guiderails mounted to the vehicle body. Sliding doors may latch when closed to ensure that the door does not accidentally open and also to help keep the door from falling off the guiderails during a collision. Latching systems and other mechanisms for securing doors generally rely on components (such as striker plates) that are mounted to the vehicle body. In particular, sliding doors use latches that attach to striker plates on vertical beams or pillars of the vehicle body that are located adjacent the front and rear sides of the sliding door.

In vehicles with dual sliding doors, there may be no central pillar for the doors to latch on to when the doors are fully closed.

There is a need in the art for a system and method that addresses the shortcomings discussed above.

### SUMMARY

Embodiments provide systems for latching dual sliding doors closed in a motor vehicle, including an asymmetric latch configuration.

In one aspect, a motor vehicle, includes a vehicle body and a dual sliding door system. The dual sliding door system includes a first sliding door and a second sliding door. A first lateral edge of the first sliding door overlaps with a second lateral edge of the second sliding door when the dual sliding door system is in a closed configuration, and the first sliding door and the second sliding door are configured to slide away from one another as the dual sliding door system moves from the closed configuration to an open configuration. The first sliding door includes more latches than the second sliding door.

In another aspect, a motor vehicle includes a vehicle body comprising an opening, the opening being bounded by a forward lateral body portion, a rearward lateral body portion, an upper body portion, and a lower body portion. The motor vehicle also includes a dual sliding door system that provides access to the opening in the vehicle body, the dual sliding door system comprising a front sliding door and a rear sliding door, the dual sliding door system being moveable between an opened configuration and a closed configuration. The front sliding door further includes an outer lateral front sliding door portion that is disposed adjacent to the forward lateral body portion when the dual sliding door system is in the closed configuration, and the front sliding door further includes an inner lateral front sliding door portion having a front inner lateral edge. The rear sliding door further includes an outer lateral rear sliding door portion that is disposed adjacent to the rearward lateral body portion when the dual sliding door system is in the closed configuration, and the rear sliding door further includes an inner lateral rear sliding door portion having a rear inner lateral edge. The front inner lateral edge overlaps in with the rear inner lateral edge when the dual sliding door system is in the closed configuration. The front sliding door further includes an upper front sliding door portion and a lower front sliding door portion. The rear sliding door further includes an upper rear sliding door portion and a lower rear sliding door portion. The dual sliding door system comprising a total of four latches, including a first latch, a second latch, a third latch, and a fourth latch. The first latch is disposed in the upper front sliding door portion, the first latch being configured to engage a first striker on the upper body portion of the vehicle body. The second latch is disposed in the lower front sliding door portion, the second latch being configured to engage a second striker on the lower body portion of the vehicle body. The third latch is disposed in the outer lateral front sliding door portion, the third latch being configured to engage a third striker on the forward body portion of the vehicle body. The fourth latch being disposed in the outer lateral rear sliding door portion, the fourth latch being configured to engage a fourth striker on the rearward body portion of the vehicle body.

In another aspect, a motor vehicle includes a vehicle body including an opening, the opening being bounded by a forward lateral body portion, a rearward lateral body portion, an upper body portion, and a lower body portion. The motor vehicle also including a dual sliding door system that provides access to the opening in the vehicle body, the dual sliding door system further including a front sliding door and a rear sliding door, and the dual sliding door system being moveable between an opened configuration and a closed configuration. The front sliding door further including an outer lateral front sliding door portion that is disposed adjacent to the forward lateral body portion when the dual sliding door system is in the closed configuration, and the front sliding door further including an inner lateral front sliding door portion having a front inner lateral edge. The rear sliding door further including an outer lateral rear sliding door portion that is disposed adjacent to the rearward lateral body portion when the dual sliding door system is in the closed configuration, and the rear sliding door further including an inner lateral rear sliding door portion having a rear inner lateral edge. The front inner lateral edge overlaps in with the rear inner lateral edge when the dual sliding door system is in the closed configuration. The front sliding door further includes an upper front sliding door portion and a lower front sliding door portion. The rear sliding door further includes an upper rear sliding door portion and a lower rear sliding door portion. The dual sliding door system includes a total of four latches, including a first latch, a second latch, a third latch, and a fourth latch. The first latch is disposed in the upper rear sliding door portion, the first latch being configured to engage a first striker on the upper body portion of the vehicle body. The second latch is disposed in the lower rear sliding door portion, the second latch being configured to engage a second striker on the lower body portion of the vehicle body. The third latch is disposed in the outer lateral rear sliding door portion, the third latch being configured to engage a third striker on the rearward body portion of the vehicle body. The fourth latch is disposed in the outer lateral forward sliding door portion, the fourth latch being configured to engage a fourth striker on the forward body portion of the vehicle body.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of a motor vehicle including a dual sliding door assembly, according to an embodiment;

FIG. 2A is a schematic view of an interior portion of a motor vehicle with a dual sliding door assembly, according to an embodiment;

FIG. 2B is a schematic view of an interior portion of a motor vehicle with a dual sliding door assembly in a partially open configuration, according to an embodiment;

FIG. 3A is a schematic view of a rear sliding door and a corresponding portion of a vehicle body, according to an embodiment;

FIG. 3B is a schematic view of a front sliding door and corresponding portions of a vehicle body, according to an embodiment;

FIG. 4A is a schematic view of an asymmetric latch configuration for dual sliding doors in a motor vehicle, according to an embodiment;

FIG. 4B is a schematic view of another asymmetric latch configuration for dual sliding doors in a motor vehicle, according to an embodiment;

FIG. 5 is a schematic view of an interior of a motor vehicle with dual sliding doors, including an enlarged cross-sectional view of a portion of the dual sliding doors, according to an embodiment; and

FIG. 6 is a schematic view of the interior of FIG. 5, including an enlarged cross-sectional view of the dual sliding doors following a lateral impact, according to an embodiment.

### DETAILED DESCRIPTION

Embodiments provide systems for latching dual sliding doors closed in a motor vehicle, including an asymmetric latch configuration. These systems may be used in sliding doors where only one side of each door (the forward or rearward side) is disposed adjacent to a portion of the vehicle body. As described in further detail below, these prevention systems include an asymmetric latch configuration combined with overlapping door edges, to keep the dual sliding doors closed. The overlapping door edges further reduce lateral separation between the doors during a collision.

The asymmetric latch configuration can include one latch on a first door of the dual sliding doors and three latches on a second of the dual sliding doors. Each door is latched at least to the forward or lateral sides of the vehicle body. The second door is further latched to an upper portion of the vehicle body and to a lower portion of the vehicle body.

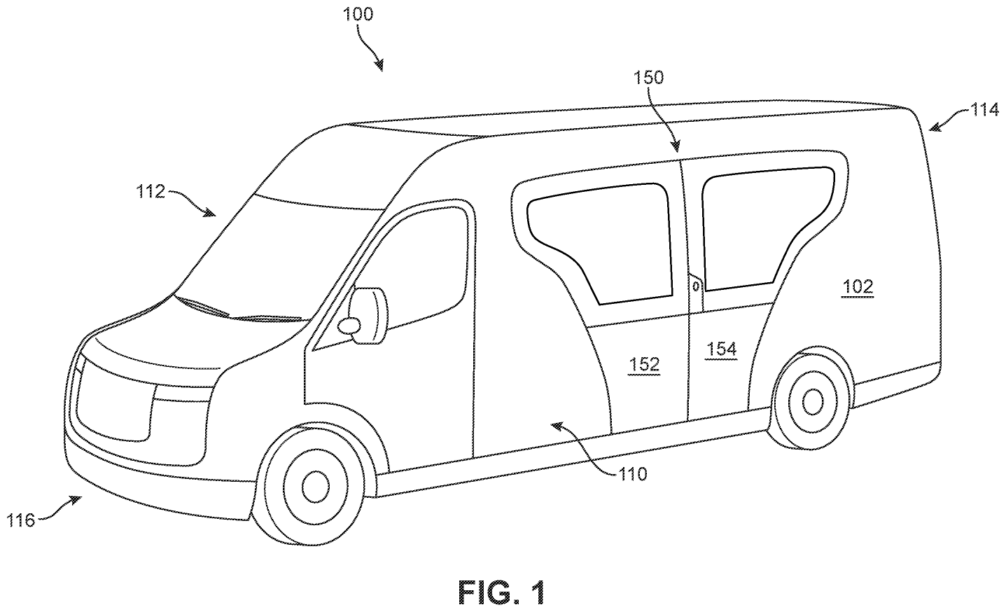

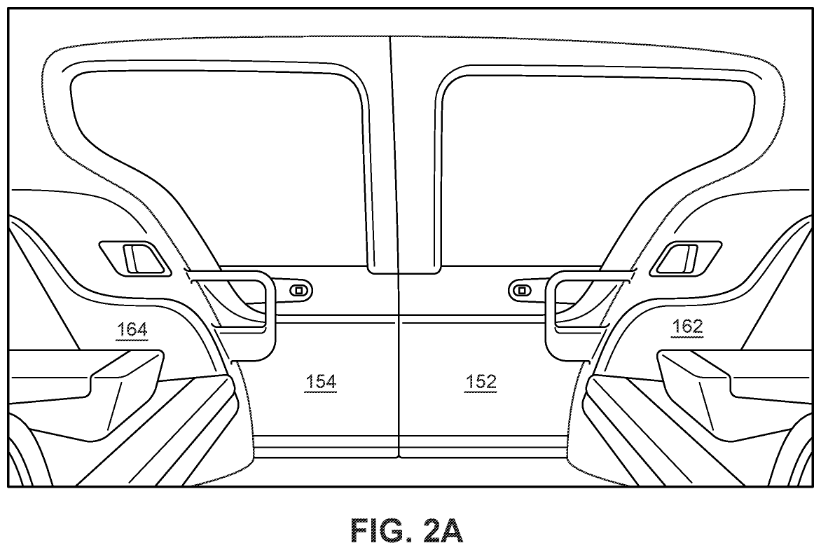

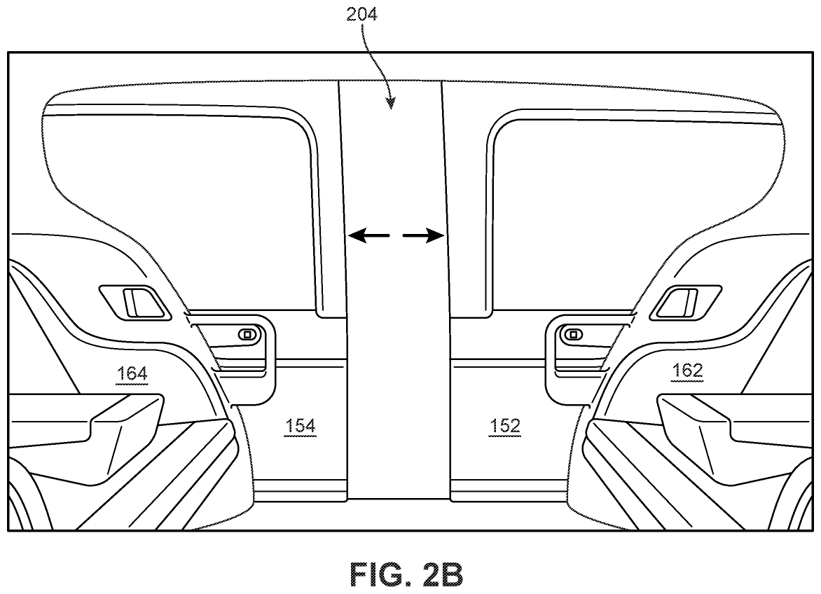

For purposes of introduction, an overview of one embodiment of the proposed systems and methods is illustrated with reference to FIGS. 1 and 2A-2B. Referring first to FIG. 1, a vehicle 100 includes a dual sliding door assembly 150 mounted to a vehicle body 102.

Simply for purposes of reference, vehicle 100 may be understood to generally comprise a forward end portion (“forward end”) 116, a rearward end portion (“rearward end”) 114, a first side portion (“first side”) 110 and a second side portion (“second side”) 112.

For purposes of convenience, the description makes reference to a longitudinal direction, which extends along a length of a component, such as the length of the vehicle 100 between the forward end 116 and rearward end 114. Similarly, the description makes reference to a lateral direction, which extends along a width of each component, such as between the first lateral side 110 and second lateral side 112 of vehicle 100. In addition, the description makes reference to a vertical direction, which is a extending along a height of each component. For example, in a vehicle, the vertical direction runs from the roof structure to the floor of the vehicle.

For clarity, vehicle 100 is depicted as a large passenger van. However, in other embodiments, a dual sliding door assembly, with the features described herein, could be incorporated into any suitable type of vehicle, including any car, van, truck, or bus. Furthermore, in some cases, a dual sliding door assembly could be incorporated into an autonomous vehicle (“AV”) which could be used, for example, to drive around large numbers of passengers.

Dual sliding door assembly 150 can comprise a first sliding door 152 and a second sliding door 164. First sliding door 152 may also be referred to as a front sliding door, as first sliding door 152 is located closer to forward end 116 of vehicle 100 than is second sliding door 154. Likewise, second sliding door 154 may also be referred to as a rear sliding door, as second sliding door 154 is located close to rearward end 114 to vehicle 100 than is first sliding door 152.

FIGS. 2A and 2B depict a view of dual sliding door assembly 150 as seen from within an interior cabin of vehicle 100. For purposes of illustration, partial views of two opposing seats (first seat 160 and second seat 162) are shown. In FIG. 2A, dual sliding door assembly 150 is shown in a “closed” position, in which first sliding door 152 and second sliding door 154 are positioned to cover the entirety of an opening within the body of vehicle 100. FIG. 2B depicts dual sliding door assembly 150 in a “partially open” position, in which first sliding door 152 and second sliding door 154 have moved away from one another and created a partial opening 204 between them. It may be appreciated that in a “fully open” position, which is not shown here, the first and second sliding doors may be positioned along vehicle 100 to create an opening between them that is sufficient for occupants of vehicle 100 to pass through as they enter and exit the vehicle.

A relevant feature of the embodiments is the lack of any central pillar or beam positioned between the doors. For example, in a conventional minivan, a vehicle may have a central pillar disposed between a front side door and a rear sliding door. Such a central pillar provides a fixed portion of the vehicle body to which the front side door and the rear sliding door can latch so that the doors stay closed until the doors are actuated to an open position at a later time. The latches may also help keep the doors closed during a collision.

In the exemplary system, removing a central pillar between the opposing sliding doors maximizes the available opening through which occupants can enter and exit the vehicle when the dual sliding door assembly is in the fully open position.

In order to ensure the sliding doors of the dual sliding door assembly can be properly latched when closed, in the absence of a central pillar between them, the embodiments include latches arranged along the top and bottom of one of the two sliding doors. Moreover, the embodiments use an asymmetric latching configuration combined with an overlapping door configuration to ensure both doors remain closed as well as to limit lateral separation between the doors in the event of a crash.

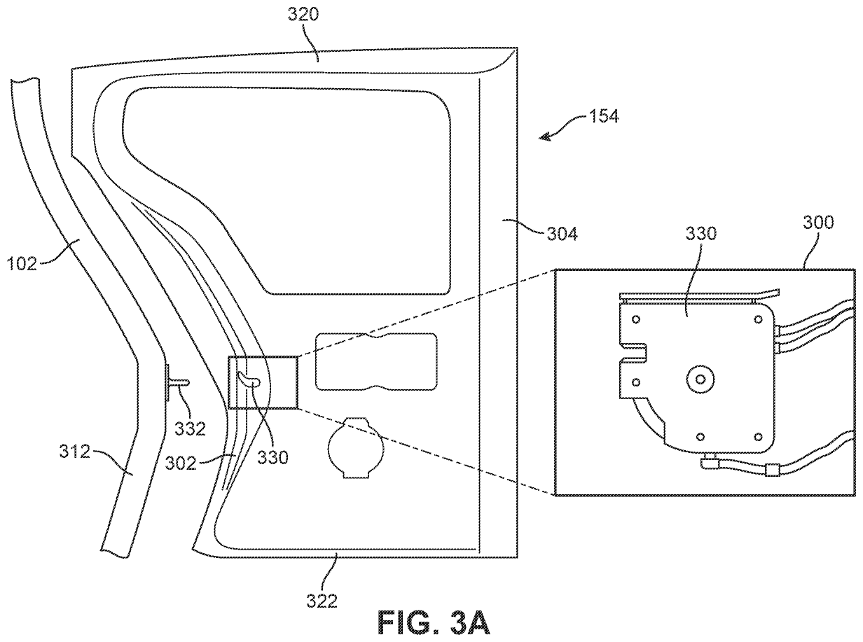

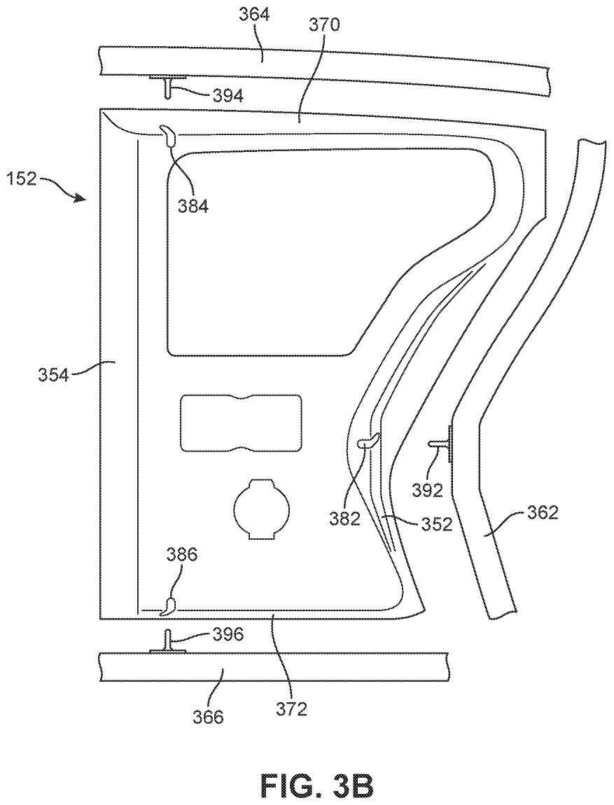

FIG. 3A is a schematic view of rear sliding door 154 (shown, for purposes of illustration, without interior panels or molding) and a portion of vehicle body 102 in order to illustrate an exemplary latching system for a sliding door. For purposes of convenience, rear sliding door 154 may be characterized as having various portions. Rear sliding door 154 may include an outer lateral rear sliding door portion 302 disposed adjacent to a rearward lateral body portion 312 of vehicle body 102. Rear sliding door 154 may also include an inner lateral rear sliding door portion 304 that is disposed adjacent to front sliding door 152 when the doors are closed. Rear sliding door 154 may also include an upper rear sliding door portion 320 and a lower rear sliding door portion 322.

Rear sliding door 154 includes a single door latch 330 (“latch 330”) that is disposed in outer lateral rear sliding door portion 302, and which may generally be hidden between panels of the door. As seen in the schematic focal view 300 of FIG. 3, door latch 330 may be an electric door latch. Any suitable electric door latches could be used. Though not shown, a vehicle may also include an electric door latch actuating mechanism to actuate the latch according to received electrical signals.

Latch 330 is aligned with, and configured to latch to, a corresponding latch striker 332 that is attached to rearward lateral body portion 312. Therefore, when rear sliding door 154 is in a fully closed position, and disposed against rearward lateral body portion 312, latch 330 can engage and latch around latch striker 332, securing the outer lateral side of the door in place.

FIG. 3B is a schematic view of front sliding door 152 and portions of vehicle body 102 in order to illustrate an example of a sliding door with three latches. For purposes of convenience, front sliding door 152 may be characterized as having various portions. Front sliding door 152 may include an outer lateral front sliding door portion 352 disposed adjacent to a forward lateral body portion 362 of vehicle body 102. Front sliding door 152 may also include an inner lateral front sliding door portion 354 that is disposed adjacent to rear sliding door 154 when the doors are closed. Front sliding door 152 may also include an upper front sliding door portion 370 that is disposed adjacent to an upper body portion 364 of vehicle body 102 when the doors are closed. Front sliding door 152 may also include a lower front sliding door portion 372 that is disposed adjacent to a lower body portion 366 of vehicle body 102 when the doors are closed. For purposes of illustration, in order to clearly show the relevant latches and latch strikers, upper body portion 364 and lower body portion 366 are shown as spaced apart from upper front sliding door portion 370 and lower front sliding door portion 372, respectively. However it may be appreciated that the upper and lower body portions may generally be disposed directly adjacent to the door (and possibly in contact with the door), when front sliding door 152 is fully closed. In some cases, upper front sliding door portion 370 may be associated with a roof structure of the vehicle body, while lower front sliding door portion 380 may be associated with a floor of the vehicle body.

In contrast to rear sliding door 154 shown in FIG. 3A, which includes a single latch, front sliding door 152 includes three latches that are all configured to engage with a corresponding striker plate on vehicle body 102. In particular, front sliding door 152 includes a first front door latch 382 (“first latch 382”) disposed in outer lateral front sliding door portion 352. First latch 382 is aligned with, and configured to latch to, a corresponding latch striker 392, which is attached to forward lateral body portion 362. Additionally, front sliding door 152 includes a second front door latch 384 (“second latch 384”) disposed in upper front sliding door portion 370. Second latch 384 is aligned with, and configured to attach to, a corresponding latch striker 394, which is attached to upper body portion 364. Front sliding door 152 also includes a third front door latch 386 (“third latch 386”) disposed in lower front sliding door portion 372. Third latch 386 is aligned with, and configured to attach to, a corresponding latch striker 396, which is attached to lower body portion 366.

Therefore, when forward sliding door 152 is in a fully closed position, first latch 382, second latch 384, and third latch 386 may engage and latch around first latch striker 392, second latch striker 394 and third latch striker 396, respectively, securing the outer lateral side, upper portion, and lower portion of the door in place.

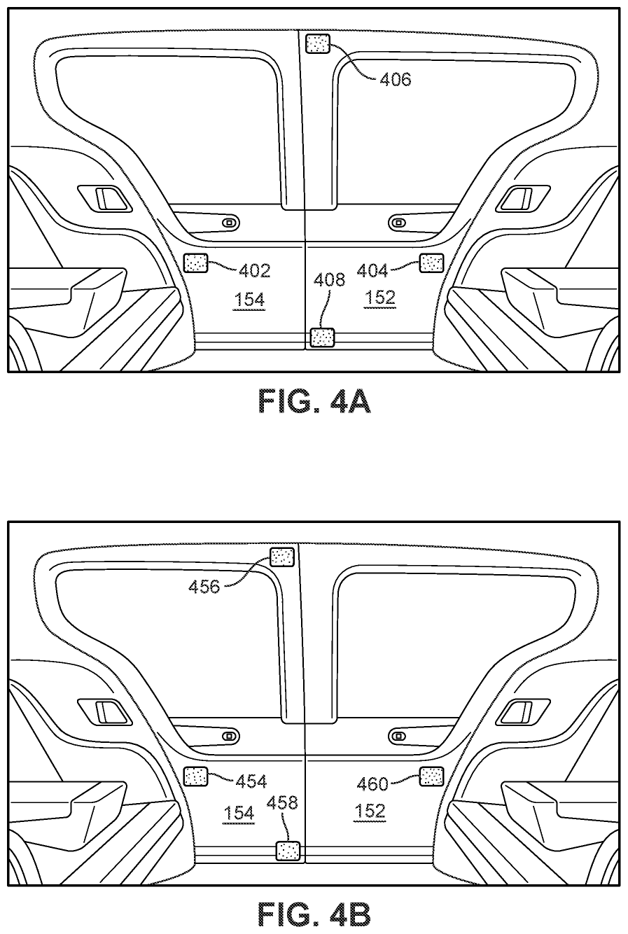

FIGS. 4A and 4B are schematic views of possible asymmetric latch configurations for a dual sliding door system. For purposes of illustration, approximate locations of the latches along each door is shown as a shaded rectangle. Likewise, for purposes of illustration, the locations of the latch strikers on the vehicle body are not shown, but it may be understood that they are located adjacent to the latch locations an in FIGS. 3A and 3B.

FIG. 4A is a schematic view of one possible asymmetric latch configuration, which corresponds to the arrangement of latches shown in FIGS. 3A and 3B. In this exemplary embodiment, rear sliding door 154 includes a single latch disposed approximately at a first rear door latch location 402. Front sliding door 154 includes three different latches, disposed approximately at first front door latch location 404, second front door latch location 406, and third front door latch location 408. This asymmetric latch configuration for front sliding door 152 and rear sliding door 154 may ensure that the vehicle doors remain closed while a vehicle is moving, and may also help keep the doors secured in place during a collision.

The embodiment depicted in FIG. 4B shows an different possible asymmetric latch configuration. In this example, rear sliding door 154 includes three latches, while front sliding door 152 includes only a single latch. More specifically, rear sliding door 154 includes three different latches, disposed approximately at first rear door latch location 454, second rear door latch location 456, and third rear door latch location 458. Front sliding door 152 includes a single latch disposed approximately at a first front door latch location 460. This alternative asymmetric latch configuration for front sliding door 152 and rear sliding door 154 may ensure that the vehicle doors remain closed while a vehicle is moving, and may also help keep the doors secured in place during a collision.

As seen in FIGS. 4A-B, latches that are positioned on a door to attach to the vehicle body at the forward or lateral side portions of the body may be disposed at substantially similar heights with respect to a vertical direction between the roof and floor of the vehicle. For example, door latch location 402 and door latch location 404 of FIG. 4A are seen to have substantially similar vertical heights. Moreover, latches that are positioned on a door to attach to the upper or lower body portions of the vehicle body may be disposed along the inner lateral of a door. For example, in FIG. 3B door latch 384 and door latch 386 are both disposed adjacent to inner lateral front sliding door portion 354. This ensures that in doors with three latches, the door is latched at each of the two lateral sides of the door.

During a collision that imparts lateral forces to a vehicle, the front sliding door and rear sliding door may be pushed inward or outward, which could lead to unwanted lateral separation between the doors. The embodiments therefore use an asymmetric latch configuration in combination with an overlapping sliding door configuration to limit lateral separation, as described in further detail below.

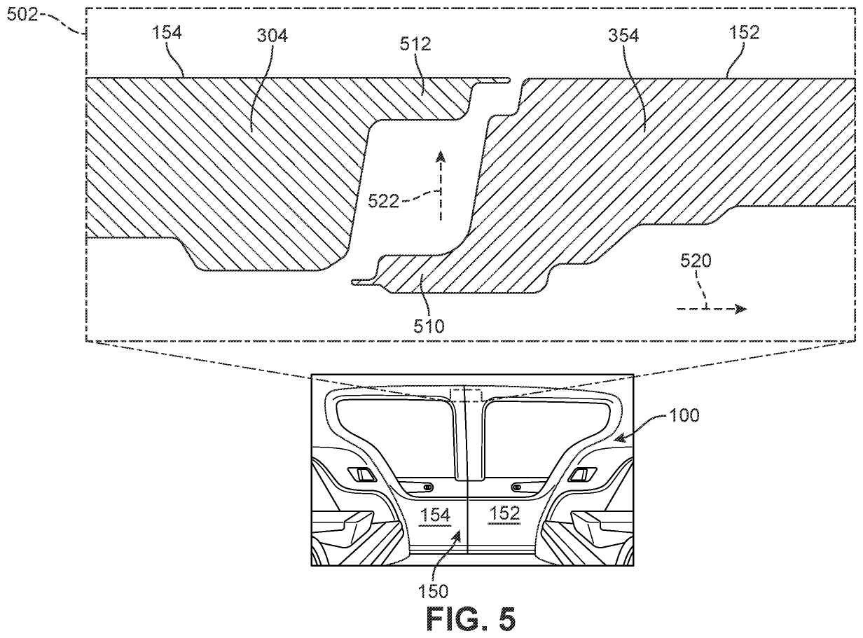

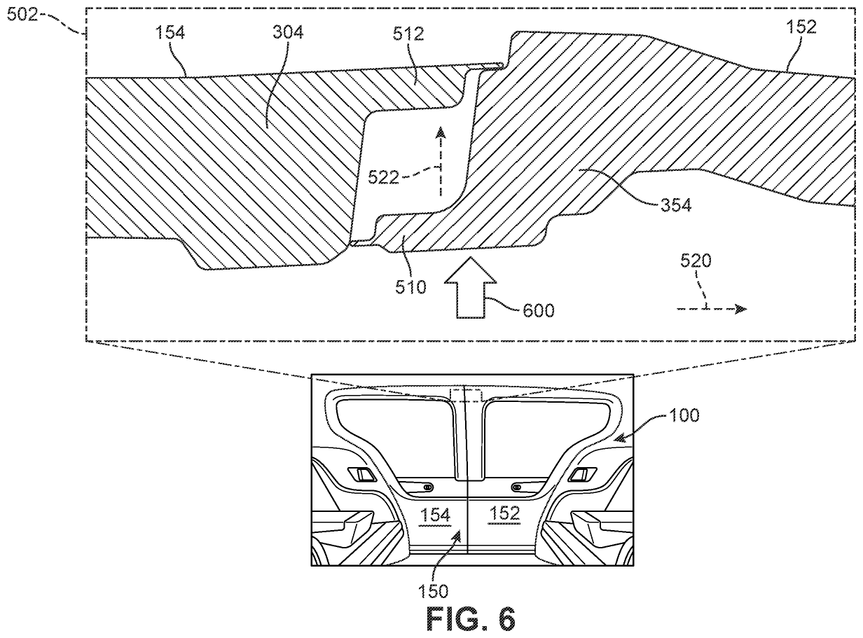

FIG. 5 shows a schematic view including an interior view of vehicle 100 with dual sliding door assembly 150, as well as an enlarged top-down cross-sectional view 502 taken at the inner lateral sides of the front and rear sliding doors. Referring to the enlarged cross-sectional view of FIG. 5, front sliding door 152 includes inner lateral front sliding door portion 354 and rear sliding door 154 includes inner lateral rear sliding door portion 304. Moreover, inner lateral front sliding door portion 354 includes a front inner lateral edge 510 and inner lateral rear sliding door portion 304 includes a rear inner lateral edge 512.

As seen in FIG. 5, front inner lateral edge 510 and rear inner lateral edge 512 are configured to overlap. That is, front inner lateral edge 510 extends rearwardly of rear inner lateral edge 512, with respect to a longitudinal direction 520. Moreover, with respect to a lateral direction 522, front inner lateral edge 510 is disposed inwardly of rear inner lateral edge 512.

To allow for this overlap, each inner lateral edge has a narrower thickness compared to adjacent portions of the doors.

FIG. 6 is a schematic view illustrating how the overlapping inner lateral edges of dual sliding door assembly 150 helps limit lateral separation between the doors during a collision. In this example, a collision results in an outwardly directed force 600 against front sliding door 152 and rear sliding door 154. As front sliding door 152 is pushed laterally outward, front sliding door 152 contacts rear inner lateral edge 512, limiting lateral separation between the two doors compared to configurations where there is no overlap between the doors.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the present embodiments.

1. A motor vehicle, comprising:
a vehicle body;
a dual sliding door system, comprising a first sliding door and a second sliding door, wherein a first lateral edge of the first sliding door overlaps with a second lateral edge of the second sliding door when the dual sliding door system is in a closed configuration, and wherein the first sliding door and the second sliding door are configured to slide away from one another as the dual sliding door system moves from the closed configuration to an open configuration; and
wherein the first sliding door includes more latches than the second sliding door.

2. The motor vehicle according to claim 1, wherein the first sliding door includes at least two latches.

3. The motor vehicle according to claim 1, wherein the first sliding door includes three latches.

4. The motor vehicle according to claim 1, wherein the first sliding door further includes an upper first sliding door portion disposed adjacent to an upper portion of the vehicle body, and wherein the first sliding door includes a latch on the upper first sliding door portion.

5. The motor vehicle according to claim 1, wherein the first sliding door further includes a lower first sliding door portion disposed adjacent to a lower portion of the vehicle body, and wherein the first sliding door includes a latch on the upper first sliding door portion.

6. The motor vehicle according to claim 1, wherein the first sliding door further includes an outer lateral sliding door portion disposed adjacent to a lateral body portion of the vehicle body, and wherein the first sliding door includes a latch on the outer lateral first sliding door portion.

7. A motor vehicle, comprising:
a vehicle body comprising an opening, the opening being bounded by a forward lateral body portion, a rearward lateral body portion, an upper body portion, and a lower body portion;
a dual sliding door system that provides access to the opening in the vehicle body, comprising a front sliding door and a rear sliding door, the dual sliding door system being moveable between an opened configuration and a closed configuration;
the front sliding door further including an outer lateral front sliding door portion that is disposed adjacent to the forward lateral body portion when the dual sliding door system is in the closed configuration, and the front sliding door further including an inner lateral front sliding door portion having a front inner lateral edge;
the rear sliding door further including an outer lateral rear sliding door portion that is disposed adjacent to the rearward lateral body portion when the dual sliding door system is in the closed configuration, and the rear sliding door further including an inner lateral rear sliding door portion having a rear inner lateral edge;
wherein the front inner lateral edge overlaps in with the rear inner lateral edge when the dual sliding door system is in the closed configuration;
the front sliding door further including an upper front sliding door portion and a lower front sliding door portion;
the rear sliding door further including an upper rear sliding door portion and a lower rear sliding door portion;
the dual sliding door system comprising a total of four latches, including a first latch, a second latch, a third latch, and a fourth latch;
the first latch being disposed in the upper front sliding door portion, the first latch being configured to engage a first striker on the upper body portion of the vehicle body;
the second latch being disposed in the lower front sliding door portion, the second latch being configured to engage a second striker on the lower body portion of the vehicle body;
the third latch being disposed in the outer lateral front sliding door portion, the third latch being configured to engage a third striker on the forward body portion of the vehicle body;
and the fourth latch being disposed in the outer lateral rear sliding door portion, the fourth latch being configured to engage a fourth striker on the rearward body portion of the vehicle body.

8. The motor vehicle according to claim 7, wherein each of the first latch, the second latch, the third latch, and the fourth latch, is an electric vehicle door latch.

9. The motor vehicle according to claim 7, wherein the front inner lateral edge is thinner than an adjacent portion of the front sliding door.

10. The motor vehicle according to claim 7, wherein the rear inner lateral edge is thinner than an adjacent portion of the rear sliding door.

11. The motor vehicle according to claim 7, wherein the upper body portion of the vehicle body is part of a roof structure of the motor vehicle.

12. The motor vehicle according to claim 7, wherein the lower body portion of the vehicle body is part of a floor structure of the motor vehicle.

13. The motor vehicle according to claim 7, wherein the third latch and the fourth latch are disposed at substantially similar vertical heights.

14. A motor vehicle, comprising:
a vehicle body comprising an opening, the opening being bounded by a forward lateral body portion, a rearward lateral body portion, an upper body portion, and a lower body portion;
a dual sliding door system that provides access to the opening in the vehicle body, comprising a front sliding door and a rear sliding door, the dual sliding door system being moveable between an opened configuration and a closed configuration;
the front sliding door further including an outer lateral front sliding door portion that is disposed adjacent to the forward lateral body portion when the dual sliding door system is in the closed configuration, and the front sliding door further including an inner lateral front sliding door portion having a front inner lateral edge;
the rear sliding door further including an outer lateral rear sliding door portion that is disposed adjacent to the rearward lateral body portion when the dual sliding door system is in the closed configuration, and the rear sliding door further including an inner lateral rear sliding door portion having a rear inner lateral edge;
wherein the front inner lateral edge overlaps in with the rear inner lateral edge when the dual sliding door system is in the closed configuration;
the front sliding door further including an upper front sliding door portion and a lower front sliding door portion;
the rear sliding door further including an upper rear sliding door portion and a lower rear sliding door portion;
the dual sliding door system comprising a total of four latches, including a first latch, a second latch, a third latch, and a fourth latch;
the first latch being disposed in the upper rear sliding door portion, the first latch being configured to engage a first striker on the upper body portion of the vehicle body;
the second latch being disposed in the lower rear sliding door portion, the second latch being configured to engage a second striker on the lower body portion of the vehicle body;
the third latch being disposed in the outer lateral rear sliding door portion, the third latch being configured to engage a third striker on the rearward body portion of the vehicle body;
and the fourth latch being disposed in the outer lateral forward sliding door portion, the fourth latch being configured to engage a fourth striker on the forward body portion of the vehicle body.

15. The motor vehicle according to claim 14, wherein each of the first latch, the second latch, the third latch, and the fourth latch, is an electric vehicle door latch.

16. The motor vehicle according to claim 14, wherein the front inner lateral edge is thinner than an adjacent portion of the front sliding door.

17. The motor vehicle according to claim 14, wherein the rear inner lateral edge is thinner than an adjacent portion of the rear sliding door.

18. The motor vehicle according to claim 14, wherein the upper body portion of the vehicle body is part of a roof structure of the motor vehicle.

19. The motor vehicle according to claim 14, wherein the lower body portion of the vehicle body is part of a floor structure of the motor vehicle.

20. The motor vehicle according to claim 14, wherein the third latch and the fourth latch are disposed at substantially similar vertical heights.
